(19) United States
(12) Patent Application Publication
(10) Pub. No.: US 2025/0105577 A1
(43) Pub. Date: Mar. 27, 2025

(54) APPARATUS FOR CORRECTING ASTIGMATISM OF A LASER BEAM

(71) Applicant: TRUMPF Lasersystems for Semiconductor Manufacturing GmbH, Ditzingen (DE)

(72) Inventors: Martin Lambert, Korb (DE); Tolga Ergin, Bietigheim-Bissingen (DE); Andreas Hopf, Möglingen (DE); Jens Wägerle, Kirchheim (DE); Oliver Schlosser, Filderstadt (DE)

(21) Appl. No.: 18/976,404

(22) Filed: Dec. 11, 2024

Related U.S. Application Data
(63) Continuation of application No. PCT/EP2022/066608, filed on Jun. 17, 2022.

(51) Int. Cl. H01S 3/00; G02B 7/185

(52) U.S. Cl. CPC H01S 3/0071; G02B 7/185

(57) ABSTRACT

An apparatus for transmitting and/or reflecting a laser beam for at least partially correcting astigmatism of the laser beam includes an optical element for transmitting and/or reflecting the laser beam. The optical element is deformable by an external force. The apparatus further includes at least four supports for the optical element arranged along an imaginary circle. The at least four supports are aligned diametrically opposite one another in pairs. The apparatus further includes at least two deformation elements for exerting the external force on the optical element. The at least two deformation elements are arranged diametrically to one another with respect to a center of the imaginary circle through the at least four supports. Each of the at least two deformation elements is arranged on an angle bisector of an angle defined by two adjacent supports and the center of the imaginary circle through the at least four supports.

### CROSS REFERENCE TO RELATED APPLICATIONS

This application is a continuation of International Application No. PCT/EP2022/066608 (WO 2023/241813 A1), filed on Jun. 17, 2022. The aforementioned application is hereby incorporated by reference herein.

### FIELD

Embodiments of the present invention relate to an apparatus for transmitting and/or reflecting a laser beam for at least partially correcting astigmatism of the laser beam. Embodiments of the present invention also relate to a laser system having such an apparatus.

### BACKGROUND

DE 10 2006 047 666 A1 discloses a projection lens comprising lens elements that are deformable by actuators. The actuators act with forces on the lens elements, wherein the forces have opposite directions. This deforms the lens elements in a way that counteracts astigmatism of a laser beam passing through the lens elements. The actuators are preferably arranged at the respective circumference of the lens elements.

DE 10 2017 217 695 A1 relates to a method for modifying a deformation behavior of a mirror in an EUV system by means of a piezoelectric layer of the mirror and an electrode arrangement on the piezoelectric layer. As a result, undesired deformation behavior, for example due to heating of the mirror, can be reduced.

WO 2007/000171 A1 discloses a mirror arrangement in a laser processing machine which comprises an adaptive mirror. Arranged in the cavity of a mount of the mirror is an electrorheological or magnetorheological fluid in order to change the focal length of the mirror by applying pressure to the rear side of the mirror.

The apparatuses known from the prior art have a comparatively complex structure.

### SUMMARY

Embodiments of the present invention provide an apparatus for transmitting and/or reflecting a laser beam for at least partially correcting astigmatism of the laser beam. The apparatus includes an optical element for transmitting and/or reflecting the laser beam. The optical element is deformable by an external force. The apparatus further includes at least four supports for the optical element arranged along an imaginary circle. The at least four supports are aligned diametrically opposite one another in pairs. The apparatus further includes at least two deformation elements for exerting the external force on the optical element. The at least two deformation elements are arranged diametrically to one another with respect to a center of the imaginary circle through the at least four supports. Each of the at least two deformation elements is arranged on an angle bisector of an angle defined by two adjacent supports and the center of the imaginary circle through the at least four supports.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows schematically a top view of an apparatus for transmitting and/or reflecting a laser beam for at least partially correcting astigmatism of the laser beam according to some embodiments;

FIG. 2 shows schematically a first cross section according to the line A-A from FIG. 1 through the apparatus, according to some embodiments;

FIG. 3 schematically shows a second cross section according to the line B-B from FIG. 1 through the apparatus, according to some embodiments; and

FIG. 4 schematically shows a laser system comprising the apparatus according to some embodiments.

### DETAILED DESCRIPTION

Embodiments of the present invention provide an apparatus for correcting astigmatism of a laser beam which has a simple structure and yet enables precise correction of the astigmatism. Embodiments of the present invention also provide a laser system including such an apparatus.

According to some embodiments, an apparatus includes the following elements:
an optical element for transmitting and/or reflecting the laser beam which is deformable by an external force;
at least four supports for the optical element, which are arranged along an imaginary circle, with the supports being aligned diametrically opposite one another in pairs;
at least two deformation elements for exerting a force on the optical element, wherein the deformation elements are arranged diametrically to one another with respect to the center of the circle through the supports, wherein the deformation elements are arranged in each case on an angle bisector of an angle defined by two adjacent supports and the center of the circle through the supports.

The deformation elements are designed to act with forces on the optical element, wherein the supports develop counterforces, as a result of which the optical element is deformed. The connecting sections between the diametrically arranged supports preferably define tilt axes along which the optical element is not deformed or only slightly deformed. The deformation of the optical element is strongest in particular along the connecting section of the deformation elements when the deformation elements act on the optical element. Thereby, a focal length of the optical element in the plane determined by this connecting section and an optical axis of the optical element, and thus an astigmatism of the laser beam, can be effectively changed, preferably corrected. Advantageously, only comparatively few and simple components are required for this purpose. The deformation elements are designed in particular as tension and/or compression pieces, which cause a tensile and/or compressive force to act on the optical element. For this purpose, the deformation elements are preferably moved to the optical element and exert the compressive force on the optical element.

In particular, astigmatic wavefront deviations of laser beams, especially in CO₂ laser beam guides, can be influenced by the apparatus. This preferably relates to a wavefront characterized by a fifth-order Zernike polynomial (Z₅) or those of a higher order and to the aberrations associated with such a wavefront. Using the apparatus, it is preferably possible to influence a wavefront which has an astigmatic deviation from a desired shape of the wavefront as follows: elimination, generation, reduction and/or increase of the astigmatic deviation.

The supports form a defined bearing for the optical element. The supports are preferably arranged at an edge region of the optical element. The edge region is defined in particular as a portion of the optical element that runs along the edge of the optical element and extends to half the distance between the edge of the optical element and the center of the optical element, preferably up to one third of the distance between the edge of the optical element and the center point of the optical element. The external forces are introduced into the optical element by way of the deformation elements in defined regions at the respective angle bisectors between the supports. In this case, the deformation of the optical element is intensified in particular by an increase in the forces acting thereon, in particular a pressure on the optical element. The optical element is preferably designed to be planar.

The imaginary connecting sections between two respective supports which are arranged diametrically in pairs are perpendicular to one another in a preferred embodiment of the apparatus. In this embodiment, a quarter of the imaginary circle passes in each case through the supports between adjacent supports, and the supports are therefore arranged rotationally symmetrically. As a result, they support the optical element in a stable manner. The forces acting on the optical element are also comparatively easy to determine.

In a further configuration, the apparatus comprises compression springs, which together with the supports form holders of the optical element. The compression springs push the optical element against the supports. This means that the optical element is fixed in its position, especially when the deformation elements do not act on the optical element. Preferably, an unintended displacement perpendicular to the desired force direction with which the deformation pieces act on the optical element is also prevented. Such a displacement might be caused by slight deviations of the apparatus from its target structure, for example.

In a development of this configuration, the supports are arranged on a front side of the optical element and the compression springs are arranged on the rear side of the optical element opposite the front side of the optical element. The optical element can then be simply fixed by clamping it between the supports and the compression springs.

The supports are advantageously in the form of underprops. By placing the optical element on the underprops, the optical element can be brought into its operating position easily.

In a preferred embodiment, the contact regions between the supports and the optical element are each line-shaped. The supports are aligned in particular along the connecting sections between the diametric supports. The connecting sections form tilt axes along which the optical element is not deformed or only slightly deformed. This property is reinforced by the linear contact regions in which the supports support the optical element, thus preventing deformation. Preferably, the supports form four line underprops on which the optical element rests.

The supports are preferably each in the form of cylindrical rollers. Cylindrical rollers are characterized by stability and durability.

The apparatus has in an advantageous embodiment a housing and alignment means for uniformly pivoting and fixing the optical element, the supports, and the deformation elements in different rotational positions at the housing. Here, the angular position of the optical element, of the supports, and of the deformation elements in relation to a reference axis through the housing is changed. The optical element, the supports, and the deformation elements are fixed in the new angular position, with the reference axis being used for measuring the angle of rotation. The deformation elements cause the strongest deformation of the optical element along the imaginary connecting section between the deformation elements. In this embodiment, the deformation elements and thus also the imaginary connecting section between the deformation elements can be pivoted relative to the housing, with the result that the plane through the connecting section and an optical axis of the optical element, in which the focal length of the optical element is most strongly changed, is also pivoted in order to influence the astigmatism of the laser beam. With a suitable alignment of this plane, in particular an astigmatism of the laser beam, which is already present before the laser beam is incident on the optical element, can be increased or decreased. In this embodiment, it is also possible to realign a wavefront with an astigmatic deviation by pivoting the optical element relative to the housing without the action of a force from the deformation elements. This allows the alignment of an astigmatic deviation of the wavefront with respect to the angular position, which deviation is caused by the optical element, to be set.

In a development of the aforementioned embodiment, the rotational positions refer to an optical axis of the optical element. The optical element is pivoted in particular about the optical axis of the optical element. The optical axis of the optical element runs in particular through the center point of the optical element and/or the center of the imaginary circle through the supports.

The distance between the deformation elements is preferably smaller than or equal to the diameter of the imaginary circle through the supports. The deformation elements are arranged in particular at a smaller or the same distance from the center point of the optical element than/as the supports. The deformation elements are located in particular in the edge region of the optical element.

In a further embodiment, the apparatus comprises exactly two deformation elements. This results in a simple structure of the apparatus.

A preferred configuration is characterized in that the apparatus comprises exactly four supports. This gives the apparatus a simple structure, especially in combination with the aforementioned embodiment.

The optical element is advantageously elastically deformable. The deformation of the optical element then adapts to different forces exerted by the deformation elements and can thus be flexibly set. With a targeted introduction of force into the regions of the optical element defined by the deformation elements on the respective angle bisectors between the adjacent supports, a deformation of the optical element is effected, which counteracts the specific astigmatism of a laser beam which is transmitted and/or reflected by the optical element. Owing to a settable introduction of force, deformations of the optical element of different extents can be effected here in order to correct different extents of astigmatic deformations of a wavefront of the laser beam.

Preferably, the optical element is a mirror and/or lens element.

Furthermore, the deformation elements are preferably in the form of threaded pins, screws and/or piezo elements. The deformation elements are in particular suitable to bring about a compressive force and/or tensile force.

A laser system has a target material irradiable with the laser beam, in particular in the form of tin droplets, for generating EUV radiation (extreme ultraviolet radiation), and an apparatus according to any of the aforementioned embodiments for correcting astigmatism of the laser beam. In a laser system of this type, astigmatism of the laser beam can be corrected in a structurally simple manner in particular to enable better focusing of the laser beam.

The features mentioned above and those still to be explained below can be used in each case individually or together in any desired combinations. The embodiments shown and described should not be understood as an exhaustive list, but rather are of an exemplary character.

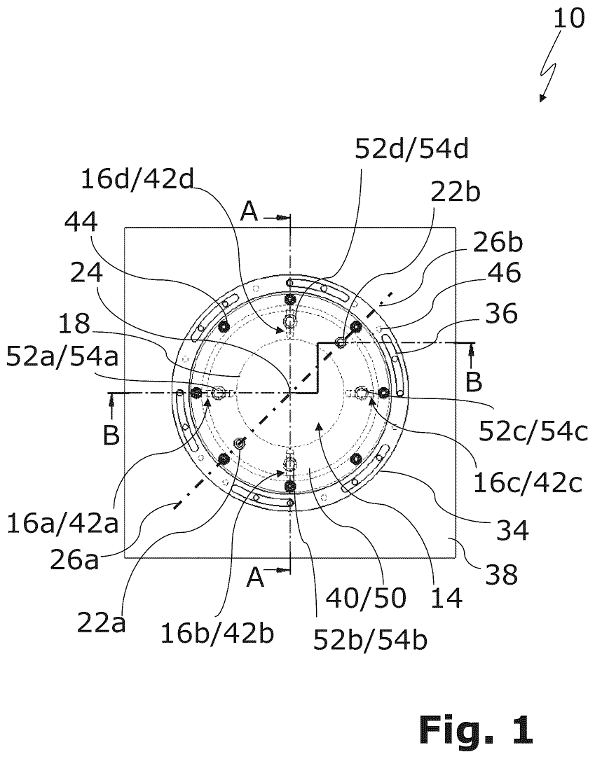

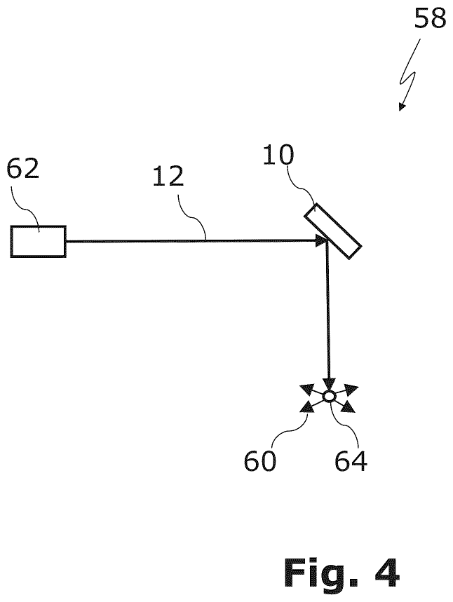

FIG. 1 shows a top view of an apparatus 10 for transmitting and/or reflecting a laser beam 12 (see FIG. 4) for at least partially correcting astigmatism of the laser beam 12. The laser beam 12 is transmitted and/or reflected by an optical element 14 whose shape is variable by an external force. The optical element 14 is here in the form of an elastically deformable mirror, which reflects the laser beam 12.

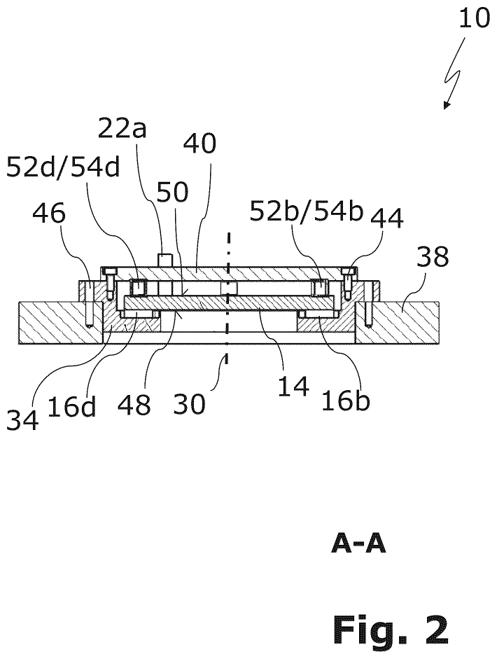

The optical element 14 rests with a front side 48 (see FIG. 2) on four supports 16a, 16b, 16c, 16d, here in the form of underprops 42a, 42b, 42c, 42d, which are designed as cylindrical rollers.

On a rear side 50 of the optical element 14 (cf. FIG. 2), which lies opposite the front side 48, compression springs 52a, 52b, 52c, 52d are arranged, which push the optical element 14 against the supports 16a-16d and fix it in its position. The compression springs 52a-52d together with the supports 16a-16d form holders 54a, 54b, 54c, 54d of the optical element 14.

The supports 16a-16d are arranged along an imaginary circle 18, wherein in each case a quarter of the circle 18 extends between the supports 16a-16d (for reasons of clarity, the circle 18 in FIG. 1 is drawn with a slightly smaller diameter). As a result, the supports 16a-16d are aligned diametrically opposite one another in pairs. The imaginary connecting sections between in each case two supports 16a-16d, which are arranged diametrically in pairs, are perpendicular to one another.

In addition, the apparatus 10 has two deformation elements 22a, 22b, wherein the deformation elements 22a, 22b are arranged diametrically to one another with respect to the center 24 of the imaginary circle 18 through the supports 16a-16d. The deformation elements 22a, 22b are each located on an angle bisector 26a, 26b of an angle defined by two adjacent supports 16a, 16b and 16c, 16d, respectively, and the center 24 of the circle 18 through the supports 16a-16d. The angles lie opposite one another. Through the deformation elements 22a, 22b, forces, in particular compressive forces, can be introduced into the optical element 14, wherein the supports 16a-16d exert counterforces on the optical element 14, as a result of which the optical element 14 changes its shape, in particular along the imaginary connecting section through the deformation elements 22a, 22b. Thus, the focal length of the optical element 14 is changed in the plane that is determined by the imaginary connecting section between the deformation elements 22a, 22b and the optical axis 30 (see FIG. 2) of the optical element 14 in order to influence the astigmatism of the laser beam 12 (see FIG. 4).

In this case, the imaginary connecting sections between the diametric supports 16a, 16c and 16b, 16d form tilt axes along which the optical element 14 is not or only slightly deformed when forces, in particular compressive forces, are exerted on the optical element 14 by the two deformation elements 22a, 22b. Due to the elongated shape of the supports 16a-16d in the form of cylindrical rollers, the contact regions between the supports 16a-16d and the optical element 14 are in each case line-shaped. In this case, the supports 16a-16c and thus also the contact regions are aligned in the direction of the connecting sections in order to strengthen the resistance of the optical element 14 against deformations along the tilt axes due to the abovementioned counterforces of the supports 16a-16d.

Located in a receiving flange 34 are alignment means, of which one is denoted by 36 as an example, for uniformly pivoting and fixing the optical element 14, the supports 16a-16d and the deformation elements 22a, 22b in different rotational positions at a housing 38 (cf. FIG. 2). The alignment means 36 have slots, which, for example, further have screws for fixing the optical element 14 in the respective rotational position. The rotational positions refer to the optical axis 30 of the optical element 14 (see FIG. 2), which runs through the center point of the optical element 14 in the top view, which center point here coincides with the center 24 of the circle 18 through the supports 16a-16d.

The optical element 14 is protected by a cover 40 (see FIG. 2), wherein the cover 40 is fastened to the receiving flange 34 via first fastening means, one of which is denoted by 44 in the drawing as an example. The receiving flange 34 is fastened to the housing 38 via second fastening means, one of which is denoted by 46 in the drawing as an example.

FIG. 2 shows a first cross section through the apparatus 10 along the section line A-A in FIG. 1. In particular, it shows that the optical element 14 rests with the front side 48 on the supports, wherein FIG. 2 shows the supports 16b, 16d. The supports are arranged on the receiving flange 34, which is fastened in the housing 38 via the second fastening elements 46.

Arranged on the rear side 50 of the optical element 14 are the compression springs, which push the optical element 14 against the supports and fix it in its position, wherein of the compression springs, the compression springs 52b, 52d are shown in FIG. 2, which with the supports 16b, 16d form the holders 54b, 54d of the optical element 14.

The figure also shows that the compression springs 52b, 52d are arranged on the cover 40, which is fastened via the first fastening elements 44 to the receiving flange 34. The deformation elements, of which the deformation element 22a is shown in FIG. 2, pass through the cover 40, wherein the deformation elements 22a, 22b (see FIG. 1) can be moved in the direction of the optical element 14 to exert pressure on the optical element 14 and thereby deform the optical element 14. The deformation of the optical element 14 can be used to counteract astigmatism of the laser beam 12 (see FIG. 4). The optical axis 30 of the optical element 14 is also shown.

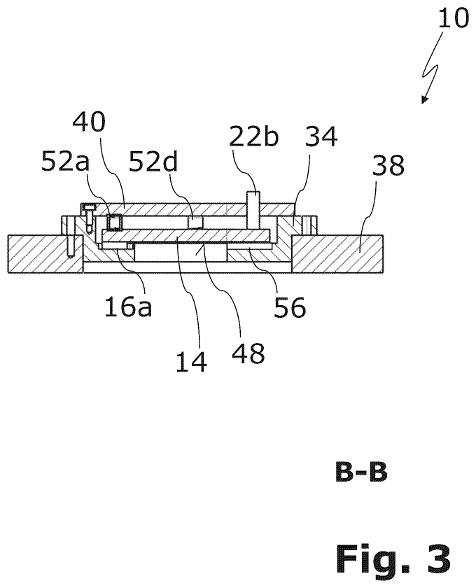

FIG. 3 shows a second cross section through the apparatus 10 along the section line B-B in FIG. 1. It shows the optical element 14 which has been placed on the supports, with FIG. 3 showing the support 16a. The compression springs act on the optical element 14 to hold the optical element in its position, wherein FIG. 3 shows the compression springs 52a, 52d. The compression springs 52a, 52d are located between the optical element 14 and the cover 40, which is fastened to the receiving flange 34, wherein the supports 16a-16d are also positioned on the receiving flange 34. The receiving flange 34 is mounted in the housing 38. Located in the front side 48 of the optical element 14 are cavities opposite the deformation elements 22a, 22b, wherein FIG. 3 shows a cavity 56 as an example, which lies opposite the deformation element 22b shown in FIG. 3. The deformation elements 22a, 22b (see FIG. 1) preferably exert a compressive force in order to move the regions of the optical element 14 which lie against the deformation elements 22a, 22b or lie on the connecting section between the deformation elements 22a, 22b, in the direction of the cavities 56. Thus, the astigmatism of the laser beam 12 (see FIG. 4), which interacts with the optical element 14, can be changed, in particular corrected.

FIG. 4 schematically shows a laser system 58 for generating EUV radiation 60 comprising the apparatus 10. The laser beam 12 generated in a laser source 62 is directed by the apparatus 10 to a target material 64, for example a tin droplet, in order to generate the EUV radiation 60. For better focusing of the laser beam 12 at the target material 64, an astigmatism of the laser beam 12 is corrected by the apparatus 10 in the process.

As described above and with reference to all the figures of the drawing, embodiments of the invention relate to an apparatus 10 for correcting astigmatism of a laser beam 12 which interacts with the apparatus 10. The apparatus 10 comprises an optical element 14 and two deformation elements 22a, 22b, which act in particular with a compressive and/or tensile force on the optical element 14 to deform it. Located on the optical element 14 are four supports 16a-16d arranged along an imaginary circle 18 in order to prevent a displacement of the optical element 14 at least in the direction of the forces acting through the deformation elements 22a, 22b. The supports 16a-16d are arranged opposite one another in pairs with respect to the center 24 of the circle 18 through the supports 16a-16d. The two deformation elements 22a, 22b also lie opposite one another with respect to the center 24 of the imaginary circle 18 through the supports 16a-16d. In this case, the deformation elements 22a, 22b are arranged on a straight line through the center 24 of the imaginary circle 18, with the line bisecting the mutually opposite angles, wherein the angles are respectively defined by adjacent supports 16a-16d and the center 24 of the circle 18 through the supports 16a-16d.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Apparatus
12 Laser beam
14 Optical element
16a-d Supports
18 Circle
22a, b Deformation elements
24 Center
26a, b Angle bisector
30 Optical axis
34 Receiving flange
36a-f Alignment means
38 Housing
40 Cover
42a-d Underprops
44 First fastening means
46 Second fastening means
48 Front side
50 Back side
52a-d Compression spring
54a-d Holders
56 Cavity
58 Laser system
60 EUV radiation
62 Laser source
64 Target material

1. An apparatus for transmitting and/or reflecting a laser beam for at least partially correcting astigmatism of the laser beam, the apparatus comprising:
an optical element for transmitting and/or reflecting the laser beam, the optical element being deformable by an external force;
at least four supports for the optical element arranged along an imaginary circle, the at least four supports being aligned diametrically opposite one another in pairs; and
at least two deformation elements for exerting the external force on the optical element, wherein the at least two deformation elements are arranged diametrically to one another with respect to a center of the imaginary circle through the at least four supports, wherein each of the at least two deformation elements is arranged on an angle bisector of an angle defined by two adjacent supports and the center of the imaginary circle through the at least four supports.

2. The apparatus as claimed in claim 1, wherein each pair of supports that are aligned diametrically to one another is arranged along an imaginary connecting section, and wherein the imaginary connecting sections of two pairs of supports are perpendicular to one another.

3. The apparatus as claimed in claim 1, further comprising compression springs, which together with the at least four supports, form holders of the optical element.

4. The apparatus as claimed in claim 3, wherein the at least four supports are arranged on a front side of the optical element, and the compression springs are arranged on a rear side of the optical element opposite the front side of the optical element.

5. The apparatus as claimed in claim 1, wherein the at least four supports are in a form of underprops.

6. The apparatus as claimed in claim 1, wherein a contact region between each support and the optical element is line-shaped.

7. The apparatus as claimed in claim 6, wherein each support is in a form of a cylindrical roller.

8. The apparatus as claimed in claim 1, further comprising a housing, and alignment elements for uniformly pivoting and fixing the optical element, the at least four supports, and the at least two deformation elements in different rotational positions at the housing.

9. The apparatus as claimed in claim 8, wherein the rotational positions refer to an optical axis of the optical element.

10. The apparatus as claimed in claim 1, wherein a distance between the at least two deformation elements is smaller than or equal to a diameter of the imaginary circle through the at least four supports.

11. The apparatus as claimed in claim 1, comprising exactly two deformation elements.

12. The apparatus as claimed in claim 1, comprising exactly four supports.

13. The apparatus as claimed in claim 1, wherein the optical element is elastically deformable.

14. The apparatus as claimed in claim 1, wherein the at least two deformation elements are in a form of threaded pins, screws, and/or piezo elements.

15. A laser system, comprising a target material irradiable with a laser beam for generating EUV radiation and an apparatus as claimed in claim 1 for correcting astigmatism of the laser beam.
